(19) United States
(12) Patent Application Publication
(10) Pub. No.: US 2014/0172570 A1
(43) Pub. Date: Jun. 19, 2014

(54) MOBILE AND AUGMENTED-REALITY ADVERTISEMENTS USING DEVICE IMAGING

(71) Applicants: Blaise Aguera y Arcas, Seattle, WA (US); Christina Summer Chen, Bellevue, WA (US)

(72) Inventors: Blaise Aguera y Arcas, Seattle, WA (US); Christina Summer Chen, Bellevue, WA (US)

(21) Appl. No.: 13/714,804

(22) Filed: Dec. 14, 2012

(51) Int. Cl. G06Q 30/02

(52) U.S. Cl. CPC G06Q 30/0261
USPC 705/14.58

(57) ABSTRACT

Mobile advertisements often involve advertisements related to the user's detected location. However, additional relevant advertisement opportunities may be identified by also identifying an image captured by the camera of the mobile device (e.g., the user may take a photo of a product under consideration, or may gaze at the product while wearing a gaze-tracking device). Advertisements relating to the product and the user's location may then be presented for a related product sold by the same store, or a lower-priced offer for the same product from a nearby competing store. Advertisements may be presented via augmented reality (e.g., integrating the advertisement with the image of the environment presented to the user), and/or compared with the cost of interrupting an inferred activity of the user. Additionally, image evaluation may be applied when the user is near an advertisement opportunity in order to conserve the resources of the mobile device.

### BACKGROUND

Within the field of computing, many scenarios involve a presentation of advertisements on a mobile device. For example, a mobile phone or a global positioning system (GPS) receiver may use geolocator components to identify the location of a user, and to present advertisements related to the user's current location and nearby opportunities. Such advertisements may be presented in order to provide information to the user that is contextually related to the user's inquiries for nearby opportunities.

Also within the field of computing, many other scenarios involve an “augmented reality” application, where an image of a user's environment is captured by a camera of the user's mobile device and presented to the user with additional information. For example, a mapping application may receive a request from a user to navigate to a particular location, such as a landmark. While capturing an image, the device may use the geolocator and other sensors (e.g., a gyroscope or accelerometer) to determine the location of the user and the orientation of the camera of the mobile device. This information may be mapped to deduce the point of view of the image, and may be compared with the coordinates of known items in order to deduce the items that may be visible within the image. As a first example, a determination that the user's location is a short distance directly south of the location of the Arc de Triomphe, and that the camera was oriented directly northward and tilted vertically while the image was captured, may enable the deduction that the Arc de Triomphe may be present within the image, and a label indicating the approximate location of the Arc de Triomphe may appear within the image. As a second example, if the camera is oriented directly eastward and the user has requested directions to the Arc de Triomphe, the image may be presented to the user with an indication that the Arc de Triomphe is located to the user's left (e.g., with a leftward arrow near the left edge of the displayed image). Such “augmented reality” applications may present many types of location-based information to the user.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

While mobile platforms may present advertisements and augmented-reality applications, additional opportunities may be available within the context of mobile devices that are not completely covered by these techniques. In many such scenarios, the mobile device may be capable of extracting more information relevant to advertising than just the user's location and point of view. In particular, the camera of the mobile device may provide significant information about the user's activities; e.g., the images captured by the camera may be evaluated to determine the user's activities and/or current focus of attention. For example, the user may be examining an object in a store, such as a product for sale. This activity may be difficult to detect from the detected location and orientation of the user (e.g., due to the portability of the objects and the typical inaccuracy of global positioning systems), but may be detectable by identifying the objects viewable in an image captured by the camera. This is particularly achievable, e.g., if the user is actively taking an image of the object, or if the mobile device is integrated with a viewing device such as a pair of glasses that are capable of detecting the user's gaze.

The object and the detected location of the user may be evaluated to determine advertising opportunities in the vicinity of the user and/or related to the object of the user's attention. As a first example, the advertising opportunity may involve advertising a related product that is available at the same store. As a second example, the advertising opportunity may involve a competing offer from an advertiser for a product that the user is evaluating in the store, and optionally identifying a nearby location where the user may purchase the product at a more advantageous price. Still further advantages may be achievable by further evaluating and/or utilizing the image of the mobile device. As a first example, optical character recognition (OCR) technologies may be applied to the image to identify the price of the product advertised at the current user's location and to present a more competitive offer at a lower price. As a second example, based on the image, location, and other sensory input, the user's activity and available attention may be inferred, and the advertising fee of the advertisement may be compared with an estimated cost of interrupting the user (e.g., advertisements may be liberally presented when the user is idle in a waiting area, but when the user is engaged in conversation, the selection of advertisements my be limited to highly relevant and/or time-sensitive advertisements that are particularly favorable to the user). As a third example, the advertisements may be presented using augmented reality techniques, e.g., integrating the advertisement with the depiction of the image of the user's environment.

However, it may be appreciated that image capture and evaluation may be resource-intensive, and if applied continuously may deplete the battery of the mobile device. Therefore, in some variations of the techniques presented herein, the device may store a set of triggers associated with various locations that may relate to an advertisement opportunity. For example, if the user's interests and location are associated with a few locations in the user's vicinity for which advertisements are available (e.g., a small number of stores at a nearby mall), the device may store the locations of such stores, and may continuously or periodically compare the location of the device with the locations of the triggers. The image evaluation techniques may then be utilized to evaluate the input from the camera only when the user is present in such locations where advertisement opportunities may arise, thereby providing efficient use of the battery capacity and other resources of the mobile device. These and other advantages may be achievable through the application of the techniques presented herein.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is an illustration of an exemplary scenario featuring a presentation of mobile advertisements to a user of a mobile device.

FIG. 2 is an illustration of an exemplary scenario featuring a presentation of mobile advertisements to a user of a mobile device relating to an object identifiable in an image captured by the camera of the mobile device in accordance with the techniques presented herein.

FIG. 3 is a flow diagram illustrating an exemplary method of presenting advertisements to a user of a mobile device in accordance with the techniques presented herein.

FIG. 4 is a component diagram illustrating an exemplary system for presenting advertisements to a user of a mobile device in accordance with the techniques presented herein.

FIG. 5 is an illustration of an exemplary computer-readable storage medium comprising computer-executable instructions that cause a climate regulator controller to operate according to the techniques presented herein.

FIG. 6 is an illustration of an exemplary scenario featuring a presentation of an advertisement on a display of a mobile device after detecting a user interaction with an object.

FIG. 7 is an illustration of an exemplary scenario featuring an advertisement server configured to store and select advertisements for a user using a user profile.

FIG. 8 is an illustration of an exemplary scenario featuring a set of triggers identifying locations associated with advertisement opportunities where a mobile device may apply the techniques presented herein.

FIG. 9 is an illustration of an exemplary scenario featuring an advertisement server configured to identify opportunities to present advertisements in response to a dynamic query generated by a mobile device.

FIG. 10 is an illustration of an exemplary scenario featuring an identification of an activity of a user and a comparison of associated advertising with a cost of interrupting the attention of the user.

FIG. 11 is an illustration of an exemplary scenario featuring an augmented reality presentation of an advertisement to a user.

FIG. 12 is an illustration of an exemplary computing environment wherein one or more of the provisions set forth herein may be implemented.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are shown in block diagram form in order to facilitate describing the claimed subject matter.

### A. Introduction

Within the field of computing, many scenarios involve a presentation of advertisements to a user in a mobile context, via a mobile device such as a phone, a tablet, or a camera. The advertisements are often selected by detecting the location of the device by a geolocator (e.g., using a geolocator such as a global positioning system (GPS) receiver, by triangulating with cellular network towers positioned at fixed locations, or by identifying the regional location of a network router through which the user's data is routed). The advertisements presented to the user on the mobile device may be related to the user's location, such as by presenting advertisements for stores in the vicinity of the user, or that are contextually related to the user's location.

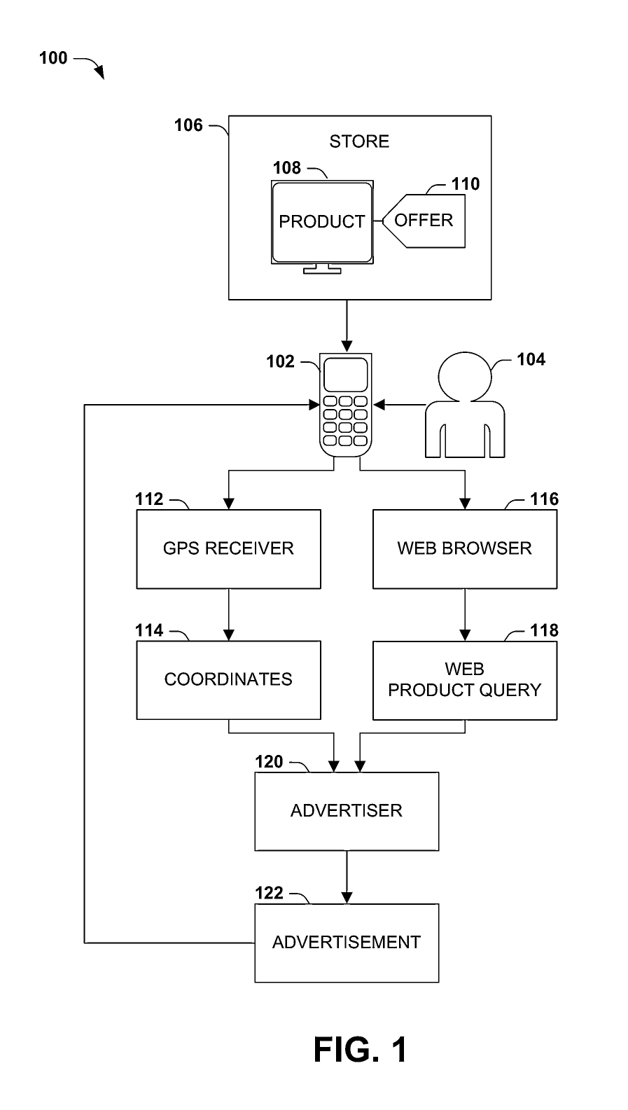

FIG. 1 presents an illustration of an exemplary scenario 100 featuring a device 112 operated by a user 104 in a mobile context, such as in within a store 106, and while the user 104 is evaluating an offer 110 on a product 108. In order to compare the offer 110 with other available offers, the user 104 may interact with a web browser 116 of the device 112 to submit a web product query 118, such as a web search requesting offers on the product 108 available through other merchants. The device 112 may also include a global positioning system (GPS) receiver 112 that is configured to generate a set of coordinates 114 identifying the location of the device 112, and the coordinates 114 may be submitted with the web product query 118 in order to provide advertisements that are related to the user's current location. For example, the evaluation of the web product query 118 and the coordinates 114 by an advertiser 120 may lead to the selection of an advertisement 122 involving a competing offer in the vicinity of the user 104, e.g., an identification of a store in the same region offering a more appealing offer 110 on the same product 108. The presentation of the advertisement 122 of the competing offer to the user 104 may therefore provide a timely, contextually relevant advertisement that may persuade the user 104 to purchase the product 108 from the advertiser 120.

Another set of techniques that are often utilized within the field of computing relate to “augmented reality,” wherein a mobile device 112 of a user 104 may present an image to the user 104 of the local environment (e.g., an image captured with a camera), whereupon various additional information about the environment may be integrated with the image. For example, a user 104 may interact with a device 112 to request directions to a location, such as a landmark like the Arc de Triomphe in Paris, France. While capturing an image of the environment, the device 112 may detect the location of the user 104, and also the orientation of the device 112 in three-dimensional space. Together, this information may enable an inference of the point of view through the camera of the device 112 (e.g., an indication that the device 112 was being held vertically and facing directly north when the image was captured). Moreover, this information may be compared with the locations of known objects in order to determine the locations of the objects with respect to the depiction of the environment. As a first example, if the device 112 is detected to be located a short distance directly south of the Arc de Triomphe and is being held in a vertical orientation while facing directly north, it may be inferred that the image may depict the Arc de Triomphe, and a label may be inserted in the image indicating the name of the landmark. As a second example, if the device 112 is detected as being held vertically but facing directly east, the image may be augmented with a left-pointing arrow near the left edge of the image in order to indicate that the Arc de Triomphe is to the left of the user 104. The presentation of the “augmented” image may provide information integrated with the context of the environment.

### B. Presented Techniques

Scenarios involving mobile advertisements, and optionally involving augmented reality, may provide relevant information that is contextually related to the location of the user 104. However, additional advertising opportunities in the mobile context may be derived by using other resources of the device 112. In particular, such resources may include an evaluation of images captured by a camera of the device 112 to identify objects that are visible to the user 104 within the image, and with which the user 104 may be interacting. As a first example, the user 104 may take an image of a product 108 that the user 104 may be considering purchasing. As a second example, the user 104 may be wearing a gaze-tracking device, such as a pair of eyeglasses or goggles with an embedded camera, that may be able to capture an image of an object that the user 104 is currently viewing, such as user interaction of the user 104 with the product 108 (e.g., an image of the product 108 held in the user's hands). As a third example, the camera of the device 112 may simply be activated to capture images that may indicate the objects around the user 104, such as signs indicating the types of products 108 around the user 104 in a store. To such images, an image evaluation or machine vision technique may be applied to recognize the objects depicted in the captured image, which may indicate the current focus and intentions of the user 104. The recognized objects, coupled with the detected location of the device 112 and the user 104, may enable a more sophisticated identification of advertising opportunities, and the presentation of advertisements to the user 104 that are more contextually relevant to not only the current location of the user 104 but also to the products 108 and other objects within the attention of the user 104.

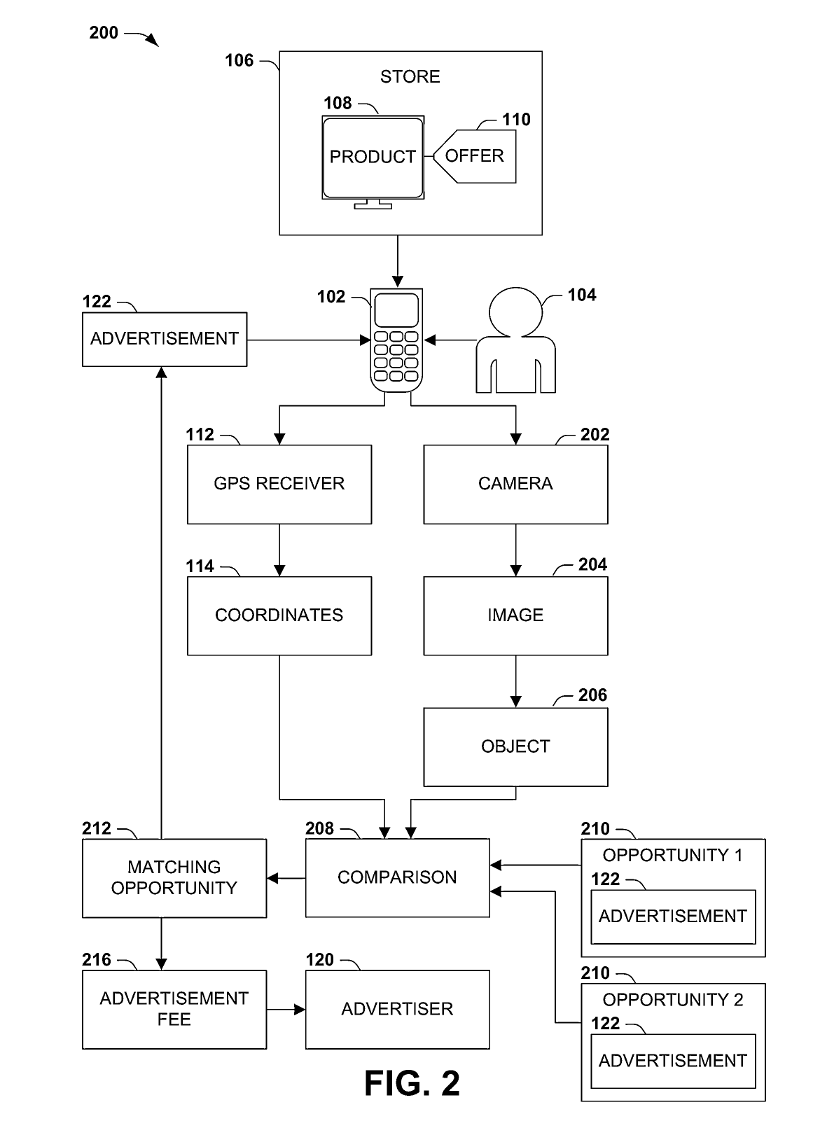

FIG. 2 presents an illustration of an exemplary scenario 200 featuring a user 104 of a device 112 evaluating an offer 110 for a product 108 in a store 106. In this exemplary scenario 200, the global positioning system (GPS) receiver 112 of the device 112 may be activated to detect a set of coordinates 114 indicating the location of the device 112 and the user 104. Additionally, a camera 202 of the device 112 may be activated to capture an image 204 of the environment of the user 104, and the device 112 may apply an image evaluation to the image 104 to recognize and the objects 206 presented therein (e.g., the products 108 available in the store 106). The device may utilize the recognition of the objects 206 and the detected coordinates 114 of the device 112 in a comparison 208 with a set of opportunities 210 to present advertisements 122 to the user 104 that are contextually related thereto. As a first example, a first opportunity 210 may indicate that a user 104 who is in a store 106 operated by an advertiser 120 and viewing a first product 108 may be persuaded by an advertisement 122 for a second product 108 that is related to the first product 108 (e.g., a monitor that is on sale and compatible with a computer that the user 104 is considering for purchase). As a second example, a second opportunity 210 may indicate that a user 104 who is in a store 106 operated by a competitor of the advertiser 120 and viewing a product 108 that is available from the advertiser 120 at a more appealing offer 110 (e.g., a lower price) may be persuaded by a presentation of an advertisement 122 indicating the more appealing offer 110 and the location of the store 106 of the advertiser 120 where the product 108 is available.

When the device 112 completes the comparison 208 and identifies a matching opportunity 212 that matches the coordinates 114 and the at least one recognized object 206, the device 1123 may select and present the advertisement 122 associated with the matching opportunity 212. For example, the advertisement 122 may be presented to the user 104 as a text-message alert or notification, or may be integrated with the image 204 of the environment for presentation to the user 104, thus presenting the advertisement 122 within the “augmented reality” of the device 112. Additionally, the advertiser 120 may be charged an advertising fee 216 specified in the matching opportunity 212, and the advertising fee 216 may be provided to the provider of the device 112 and/or provided to the user 104. In this manner, the user 104 may be presented a set of highly contextual and timely advertisements 122 relating not only to the user's location, but also to the objects 206 viewed by the user 104, in accordance with the techniques presented herein.

### C. Embodiments

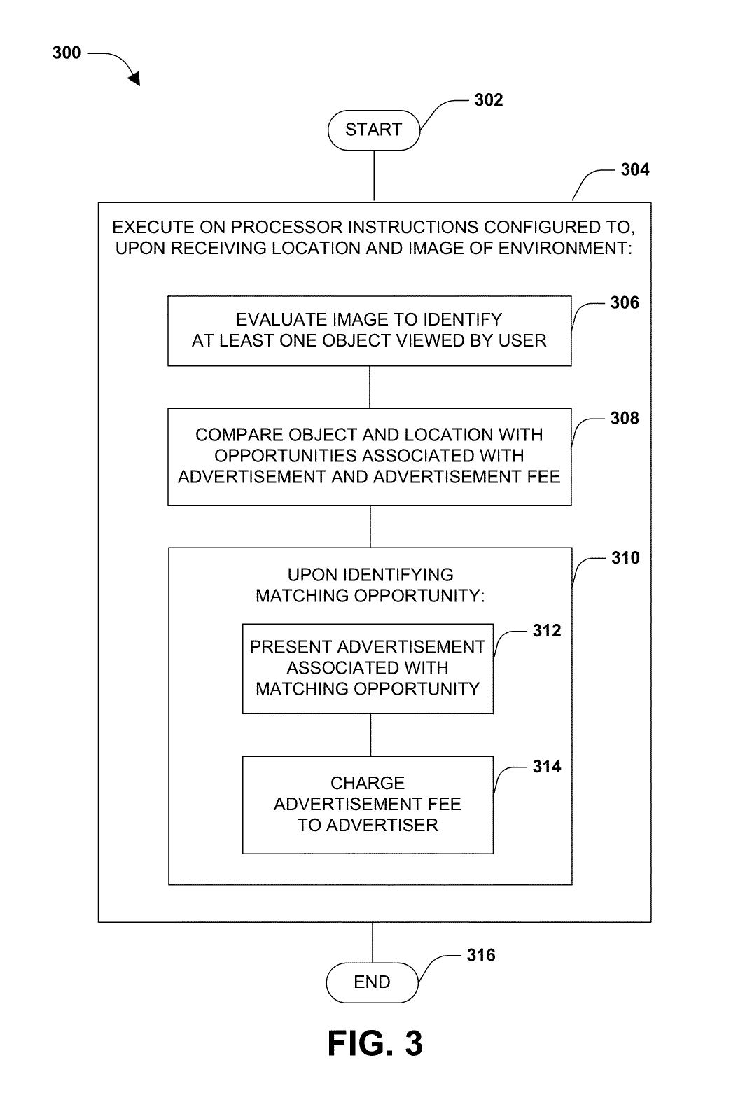

FIG. 3 presents an illustration of a first exemplary embodiment of the techniques presented herein, illustrated as an exemplary method 300 of presenting advertisements to a user 104 of a device 112 having a geolocator, a camera, and a display. The exemplary method 300 may be implemented, e.g., as a set of instructions stored in a memory device (e.g., a volatile memory circuit, a platter of a hard disk drive, a solid-state storage device, or a magnetic and/or optical disc) of the device 112 that, when executed by a processor of the device 112, cause the device 112 to present mobile advertisements to the user 104 according to the techniques presented herein. The exemplary method 300 begins at 302 and involves executing 304 the instructions on the processor of the device 112. Specifically, the instructions are configured to, upon receiving 304 a location from the geolocator and an image 204 of an environment of the user 104 from the camera 202, evaluate 306 the image 204 to identify at least one object 206 viewed by the user 104. The instructions are further configured to compare 308 the at least one object 206 and the location of the user 104 with at least one opportunity 210 associated with an advertisement 122 and an advertisement fee 216. The instructions are further configured to, upon identifying 310 a matching opportunity 212, present 312 the advertisement 122 associated with the matching opportunity 212 to the user 104, and charge 314 the advertisement fee 216 of the matching opportunity 212 to the advertiser 120. Having achieved the presentation of advertisements 122 to the user 104 based on both the location of the device 112 and the objects 206 visible in the image 204 captured by the camera 202 of the device 112, the exemplary method 300 achieves the presentation of contextually related mobile advertisements 122 to the user 104 according to the techniques presented herein, and so ends at 316.

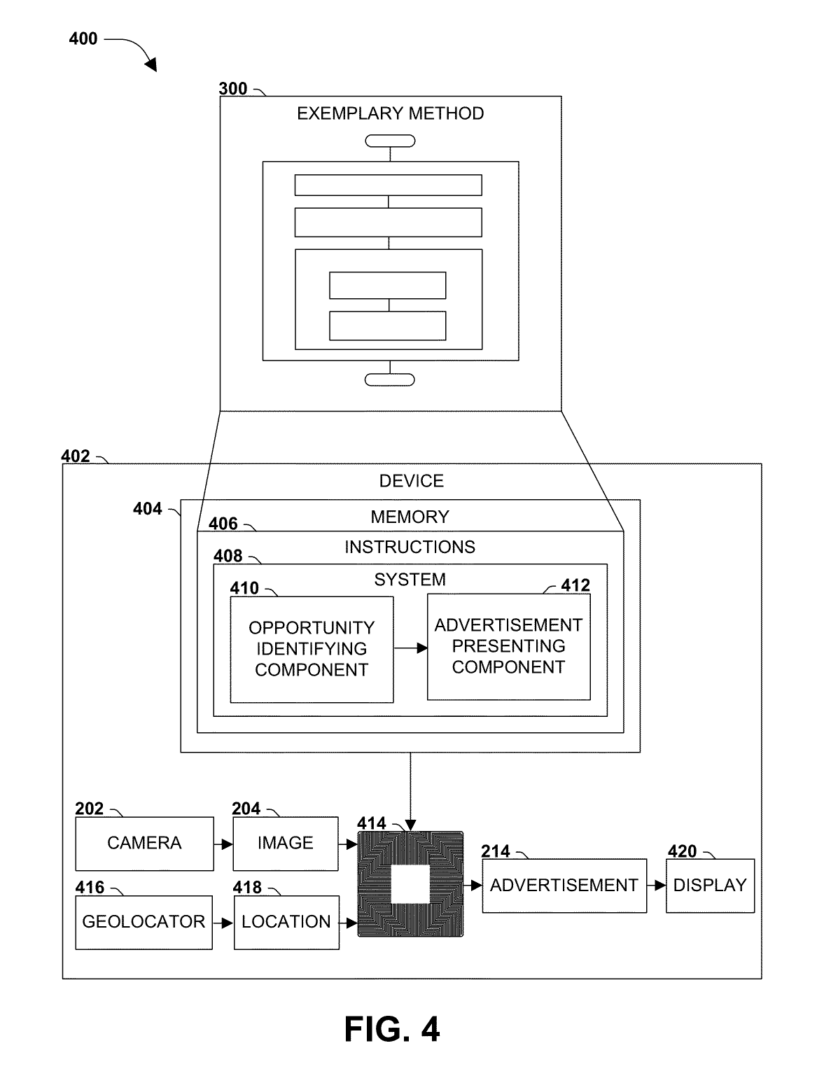

FIG. 4 presents an illustration of an exemplary scenario 400 featuring a second embodiment of the techniques presented herein. In this exemplary scenario 400, a device 402 is depicted as comprising a memory 404 (e.g., a memory circuit, a hard disk drive, a solid-state storage device, or a magnetic or optical disc), a processor 414, a camera 202, and a geolocator 416 such as a global positioning system (GPS) receiver 112. This device 402 may be configured in various ways to present mobile advertisements 122 to the user 104 in accordance with the techniques presented herein. For example, as depicted in the exemplary scenario 400 of FIG. 4, the memory 404 of the device 402 may store a set of instructions 406 that, when executed on the processor 414, provide an exemplary system 408 for presenting the mobile advertisements 122 to the user 104. This exemplary system 408 may comprise an opportunity identifying component 410, comprising instructions 408 stored in the memory 406 that cause the device 402 to, upon receiving a location 418 from the geolocator 416 and an image 204 of an environment of the user 104 from the camera 202, evaluate 306 the image 204 to identify at least one object 206 viewed by the user 104, and compare 308 the at least one object 206 and the location 418 with at least one opportunity 210 associated with an advertisement 122 and an advertisement fee 216. The exemplary system 408 may also comprise an advertisement presenting component 412, comprising instructions 408 stored in the memory 406 that cause the device 402 to, upon the opportunity identifying component 410 identifying a matching opportunity 212, present 312 the advertisement 122 associated with the matching opportunity 212 to the user 104, and charge 314 the advertisement fee 216 of the matching opportunity 212 to the advertiser 120. In this manner, the exemplary system 408 may utilize the exemplary method 300 presented in the exemplary scenario 300 of FIG. 3 to present contextually relevant mobile advertisements 216 to the user 104. Alternatively, some or all of the exemplary system 408 may comprise electronic components (e.g., a logically configured circuit or a field-programmable gate array (FPGA) that implement one or more components of the exemplary system 408 of the device. These and other embodiments may be utilized to implement the techniques presented herein.

Still another embodiment involves a computer-readable medium comprising processor-executable instructions configured to apply the techniques presented herein. Such computer-readable media may include, e.g., computer-readable storage media involving a tangible device, such as a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a CD-R, DVD-R, or floppy disc), encoding a set of computer-readable instructions that, when executed by a processor of a device, cause the device to implement the techniques presented herein. Such computer-readable media may also include (as a class of technologies that are distinct from computer-readable storage media) various types of communications media, such as a signal that may be propagated through various physical phenomena (e.g., an electromagnetic signal, a sound wave signal, or an optical signal) and in various wired scenarios (e.g., via an Ethernet or fiber optic cable) and/or wireless scenarios (e.g., a wireless local area network (WLAN) such as WiFi, a personal area network (PAN) such as Bluetooth, or a cellular or radio network), and which encodes a set of computer-readable instructions that, when executed by a processor of a device, cause the device to implement the techniques presented herein.

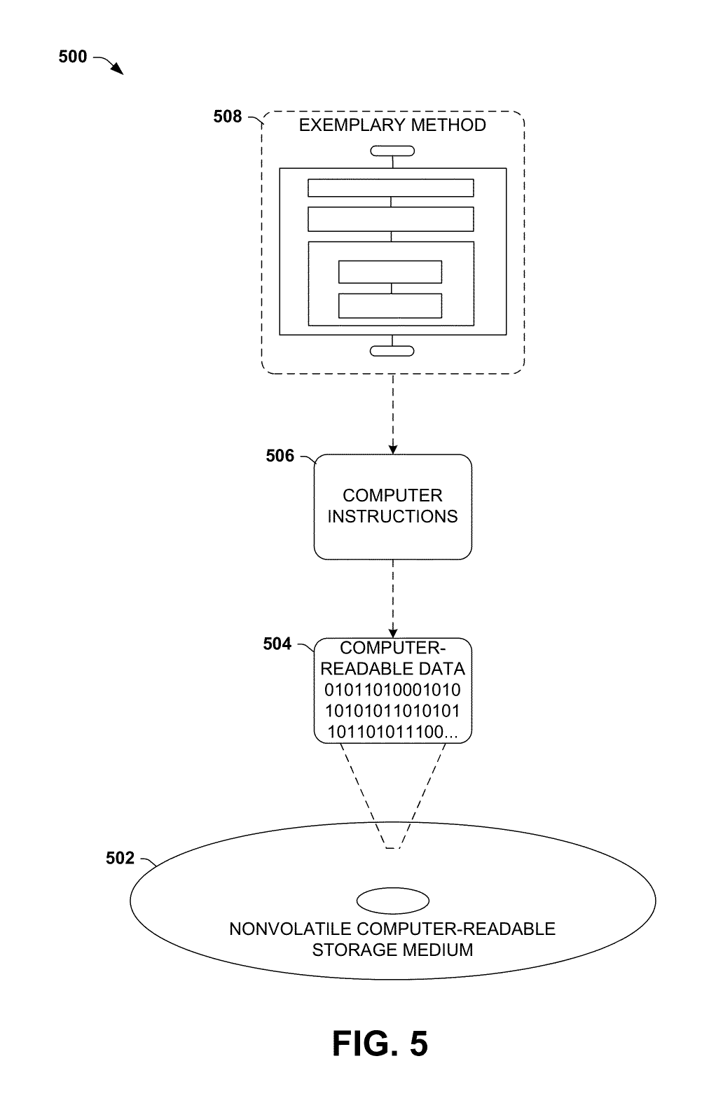

An exemplary computer-readable medium that may be devised in these ways is illustrated in FIG. 5, wherein the implementation 500 comprises a computer-readable medium 502 (e.g., a CD-R, DVD-R, or a platter of a hard disk drive), on which is encoded computer-readable data 504. This computer-readable data 504 in turn comprises a set of computer instructions 506 configured to operate according to the principles set forth herein. Some embodiments of this computer-readable medium may comprise a nonvolatile computer-readable storage medium (e.g., a hard disk drive, an optical disc, or a flash memory device) that is configured to store processor-executable instructions configured in this manner. Many such computer-readable media may be devised by those of ordinary skill in the art that are configured to operate in accordance with the techniques presented herein.

### D. Variations

The techniques presented herein may be implemented with variations in many aspects, and some variations may present additional advantages and/or reduce disadvantages with respect to other variations of these and other architectures and implementations. Moreover, some variations may be implemented in combination, and some combinations may feature additional advantages and/or reduced disadvantages through synergistic cooperation.

D1. Scenarios

A first aspect that may vary among embodiments of these techniques relates to the scenarios wherein such techniques may be utilized.

As a first variation of this first aspect, the techniques presented herein may be used with many types of devices 112, including phones, tablets, global positioning service (GPS) receiver devices, cameras, laptop and palmtop portable computers, personal digital assistants (PDAs), and wearable computers mounted in a pair of eyeglasses, goggles, or any other piece of clothing. These techniques may also be used with non-portable devices, such as workstations, servers, and kiosks, and devices embedded in vehicles, such as cars, bicycles, and airplanes.

As a second variation of this first aspect, the techniques presented herein may utilize many types of geolocators 416 configured to detect many types of locations 418. As a first example, the device 112 may include a global positioning system (GPS) receiver configured to detect the location 418 by triangulating with satellites to determine a set of coordinates 114 (e.g., latitude, longitude, and/or altitude). As a second example, the device 112 may include a cellular communication circuit that triangulates a location with cellular communication transceivers at known locations. As a third example, the device 112 may include a network adapter that communicates with a wired or wireless router identifying its location (e.g., a geographic indicator encoded in the domain name service (DNS) of the router and determinable via reverse DNS lookup). As a fourth example, the device 112 may simply include a component configured to query a nearby location identifier that indicates the location of the device 112. The geolocator 416 may be embedded in the device 112 or accessible to the device 112 through a wired or wireless connection.

As a third variation of this first aspect, the techniques presented herein may utilize many types of images 204 generated by many types of cameras 202. Such cameras 202 may include, e.g., analog and/or digital imaging, and may cover part or all of the visible spectrum, and optionally including at least some portions of the invisible spectrum, such as infrared light in a night-vision camera. Such cameras 202 may also be oriented forward (pointing toward the focus of attention of the user 104), backward (pointing toward the user 104 and the environment of the user 104), fisheye (capturing part or all of the spherical image of the environment around the device 112), and/or external (capturing an image 204 of the user 104 from an external point of view). The camera 202 may be embedded in the device 112 or accessible to the device 112 through a wired or wireless connection.

As a fourth variation of this first aspect, the techniques presented herein may involve the identification of many types of objects 206 in the image 204. As a first example, the object 206 may comprise a product 108 offered by a store 106 that the user 104 is evaluating. As a second example, the object 206 may comprise an item in the store 106 indicating that the user 104 is interested in a particular product 108, such as a sign describing the product 108, or an object 206 identifying an area of the store 106 that is associated with a particular type of product 108 (e.g., a mascot for a particular type of store 106 offering a particular type of product 108). As a third example, the object 206 may comprise a recognizable individual, such as a salesman of a particular type of product 108. As a fourth example, the object 206 may comprise a first product 108 that is related to a second product 108 that may be the subject of the advertisement 122, e.g., an accessory for the second product 108. As a fifth example, the object 206 may comprise part or all of the user 104 depicted in a particular scenario (e.g., recognizing that the user 104 is holding an object 206 in his or her hands as an evaluation of a product 108, or is participating in a test drive of a vehicle).

As a fifth variation of this first aspect, the techniques presented herein may be capable of identifying objects 206 in the image 204 in various ways. As a first example, the device 112 may identify the objects 206 in an image 204 by applying various types of image evaluation, object recognition, and/or machine vision techniques to the image 204 to identify objects 206 according to shapes, colors, size cues, and other recognizable visual indicators of the object 206. As a second example, the device 112 may send the image 204 to a service that is capable of recognizing the objects 206 in the image 204, such as a powerful server that is accessible over a wireless network, and may receive from the server a list of identified objects 206 in the image 204. As a third example, the identifying may involve a “mechanical Turk” technique, involving presenting the image 204 to a second user 104 to identify the objects 206 visible therein. As a fourth example, the identifying may be assisted by contextual cues, such as a recent expression by the user 104 of interest in the object 206, or the name of the object 206 included in a text message sent by the user 104. These and other types of variations may be compatible with the presentation of advertisements 122 according to the techniques presented herein.

D2. Opportunity and Advertisement Types

A second aspect that may vary among embodiments of these techniques relates to the types of advertisements opportunities 210 and advertisements 122 involved therein.

As a first variation of this second aspect, many types of opportunities 210 may be identified based on the location 418 and the objects 206 recognized in the image 204. As a first such example, the opportunity 210 may comprise an offer 110 to sell the product 108 depicted in the image 204 to the user 104. As a second such example, the opportunity 210 may comprise an offer 110 to sell a second product 108 to the user 104 as an alternative to the first product 108 (e.g., a less expensive and/or higher-quality product 108). As a third such example, the opportunity 210 may comprise an offer 110 to sell a second product to the user 108 that is compatible with, complementary with, and/or often sold or used with the first product 108 (e.g., an accessory for the first product 108, or a service for the product 108, such as a warranty). As a fourth such example, the opportunity 210 may comprise information about the product 108 that may persuade the user 104 to purchase the product 108 under consideration, such as a user review, or an offer 110 of a discount on the product 108 offered by the same store 106. As a fifth such example, the opportunity 120 may comprise an offer 110 persuading the user 104 to purchase the product 108 or a different product 108 not at the store 106 where the user 104 is currently located, but at a competing store 10 of the advertiser 120 (e.g., an more appealing offer 110 for the same product 108 available at a nearby competing store 106, optionally including a map showing the location of the competing store 106 and/or a navigation route to reach the competing store 106). As a sixth such example, the opportunity 210 may present particular conditions of fulfillment to persuade the user 104, such as a limited time offer encouraging the user 104 to act on the offer 110 promptly.

As a second variation of this second aspect, many types of advertisements 122 may be involved in the opportunities 210. As a first such example, the advertisement 122 may include various types of media, such as text, pictures, video, audio, and/or interactive content. As a second such example, the advertisement 122 may be targeted to the user 104 (e.g., selected based on the user's interests) and/or may specifically identify and incorporate the user 104 (e.g., presenting a generated picture of the user 104 with the product 108). As a third such example, the advertisement 122 may be presented to the user 104 in various ways, e.g., as an email message, text message, text alert, notification, or visual indicator integrated with a user interface of the device 112.

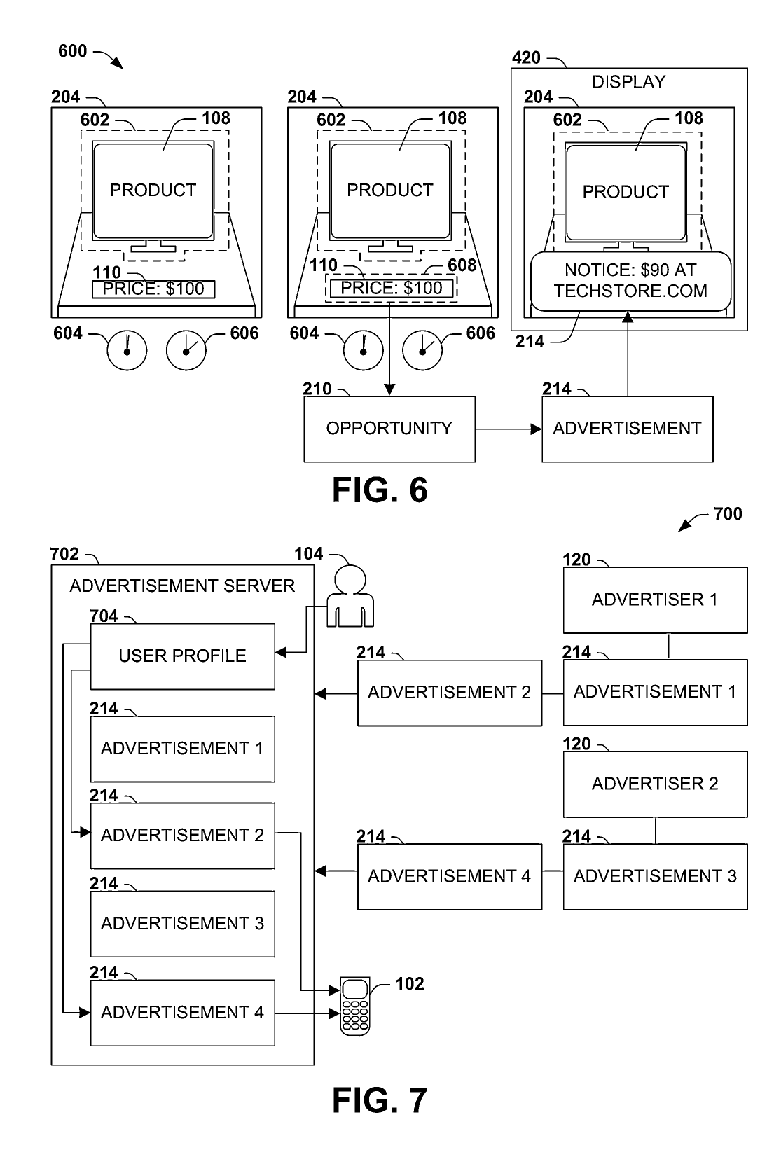

FIG. 6 presents an illustration of an exemplary scenario 600 featuring one such variation, in which the content of the image 204 is utilized to generate an advertisement 122 for presentation to the user 104. In this exemplary scenario 600, an image 204 is captured by the camera 202 and evaluated by the device 112 to identify the contents of the image 204, including a recognition 602 of a product 108, and may infer a user interaction with the product 108 (e.g., an indication that the user 104 has taken the image 204 with the camera 202 as an evaluation of the product, where such inference may be determined, e.g., by a delivery of the image 204 to a friend requesting more information). Additionally, the device 112 may endeavor to determine whether the image 204 is part of a user interaction with the product 108 or just a passing and incidental inclusion of the product 208 in the image 204. In particular, the device 112 may monitor a product interaction duration 604 of the user 104 with the product 108, and may infer user interest when the product interaction duration 604 exceeds a product interaction duration threshold 606 (e.g., a user interaction with the product 108 lasting more than ten seconds). Upon detecting the user interaction with the recognized product 108, the device 112 may identify an opportunity 210 to present an advertisement 122 associated with the product 108 and the location 418 of the user 104, and may present the advertisement 122 to the user 112. For example, if the location 418 is the store 106 of a competitor of the advertiser 120, the opportunity 210 may comprise an offer 110 for the product 108 from a competing advertiser 120 at a second product offer that is more appealing to the user 104 than the current offer 110. Moreover, as depicted in the exemplary scenario 600 of FIG. 6, the image 204 may be used to formulate the more appealing offer. For example, the image 204 may be evaluated to determine the offer 110 currently presented by the competing store 106 to the user 104 (e.g., applying optical character recognition and detecting the phrase “PRICE: $100”), and the competing offer 110 may comprise a discount on the detected price of the product 108. Additionally, the opportunity 210 may be identified as presenting the discounted offer 110 only when the user 104 is considering a higher-priced offer 110 for the product 602 in a competing store 108, and the identification fo the offer 110 currently viewed by the user 104 may trigger this opportunity 210. In this manner, the evaluation of the image 204 may facilitate the identification of the opportunity 210 and the formulation of the advertisement 122 in accordance with the techniques presented herein.

As a third variation of this second aspect, the opportunities 210 and/or advertisements 122 may be generally provided for all users 104, or may be targeted and/or personalized for a particular user 104. For example, from a large set of available opportunities 210, the opportunities 210 involved in the comparison 208 and/or the advertisements 122 presented to the user 104 may be selected as those that are relevant to the user 104, such as targeted to the user's demographics or interests, and/or limited to regions that the user 104 is likely to visit. These and other variations in the opportunities 210 and advertisements 122 may be compatible with the techniques presented herein.

D3. Advertisement Infrastructure

A third aspect that may vary among embodiments of these techniques relates to the configuration of the device 112 to apply such techniques while in use by the user 104.

As a first variation of this third aspect, the device 112 may be configured to perform the comparison 208 by sending the location 418 and objects 206 detected in an image 204 to the advertiser 120 and receiving back an advertisement 122 associated with the opportunity 210. This variation may be advantageous, e.g., for requesting and receiving up-to-date information from the advertiser 120, and/or for conserving the computational resources of the device 112 (e.g., the evaluation of the image 204, the storage of opportunities 210 and advertisements 122, and the comparison). Alternatively, the advertiser 120 may send the advertisements 122 to the device 112 for storage, and the device 112 may store the opportunities 210, perform the comparison 208 with the location 418 and the objects 206 detected in the image 204, and present an advertisement 122 when the comparison 208 determines that the associated opportunity 210 has arisen. This variation may be advantageous, e.g., for reducing network transport (i.e., the device 112 may continuously compare a previously received opportunity 210 with the images 204 and location 418, rather than having to notify the advertiser 120 continuously of the images 204, objects 206, and/or locations 418 of the user 104), and/or for preserving the privacy of the user 104 (e.g., by performing the comparison 208 of the opportunity 210 and the private data of the user 104 locally, rather than sending it to an external service). As one such example, the user 104 may have a user profile describing the user 104, and the device 112 may send the user profile to the advertiser 120, and may receive and store opportunities 210 and advertisements 122 related to the user 104 according to the description in the user profile.

As a second variation of this third aspect, an advertisement server may be utilized to store advertisements on behalf of one or more advertisers 120, and to select advertisements 214 to be stored on a device 102 and presented to a user 104. This selection may be performed, e.g., in view of a user profile describing the user 104 that is stored by the advertisement server and used to determine the advertisements 214 that are likely to be relevant and/or appealing to the user 104. This variation may be advantageous, e.g., for retaining the privacy of the user's information, including the user's identity, preferences, location 418 (e.g., the stores 106 routinely visited by the user 104), and the viewed products 108 and other objects 206 visible in the images 204 captured by the camera 202 of the device 102 of the user 104. While such information may be highly relevant to the selection of advertisements, the user 104 may be very reluctant to have this information shared with one or more advertisers 120; rather, the information may be stored by an advertisement server that is controlled by and/or trusted by the user 104 in order to perform the selection. Even greater privacy control may be provided, e.g., by providing the advertisement server only with general information about the user 104 (e.g., the user's age, general region of residence, and the types of products 108 that are of interest to the user 104), such that the advertisement server may identify opportunities 210 that may be relevant to the user 104. Such opportunities 210 may then be provided to and stored by the device 102, which may track the location 418 of the user 104 and the objects 206 visible to the user 104, and may perform the comparison 208 to determination matching opportunities 212. This architecture may therefore limit the user profile generally describing the user 104 to the advertisement server, and may restrict the actual day-to-day information about the user 104 to the user's device 102. Additionally, this architecture may represent a comparatively efficient load balancing of the comparisons (e.g., using the advertisement server to identify the general relevant of a large set of advertisements 122 to select and targeted sets of users 104, and using the devices 102 of the users 104 to evaluate the particular current circumstances of the user 104 and determine the matching opportunities 212 to present such advertisements 122).

FIG. 7 presents an illustration of an exemplary scenario 700 featuring this architectural variation, wherein an advertisement server 702 stores a set of user profiles 704 describing one or more users 104. The advertisement server 702 may receive a potentially large number of advertisements 214 from a potentially large number of advertisers 120, and may use the user profiles 704 to determine which users 104 are likely to be interested in such advertisements 214. The select advertisements 214 relevant to a user 104 may be delivered to the device 102 of the user 104, which may present relevant advertisements 214 to the user 104 when matching opportunities 212 arise. In this manner, the advertisement server 702 may mediate the interactions of the advertisers 120 and the devices 102 of the users 104, potentially enhancing the privacy and selectivity in the presentation of advertisements 214.

As a third variation of this third aspect, the comparison 208 of opportunities 210 to locations 418 and objects 206 in images 204 may be performed continuously and/or periodically by the device 112. Alternatively, the device 112 may conservatively apply such techniques in order to reduce the utilization of the resources of the device 112. For example, a mobile device, such as a phone, often comprises a limited-capacity battery, a limited amount of memory and storage capacity, and a processor 414 that is not as powerful as a workstation processor. It may be appreciated that continuously or frequently evaluating the images 204 and/or performing the comparison 208 may deplete the battery and consume memory and processor capacity. In order to reduce this inefficiency, the device 112 may be configured to perform a less computationally intensive portion of these techniques first, and then to apply the more computationally intensive portion after the first portion has completed.

As a first example of this third variation, the device 112 may conserve the image capturing, image evaluation, and/or comparison 208 until it is determined that the location 418 matches at least one opportunity 210. For example, the location 418 may be continuously or periodically compared with the locations 418 of the opportunities 210, and only when the user 104 is determined to be located in an area relating to an opportunity 210 (e.g., near the store 106 of the advertiser 120 or a competitor), the images 204 may be captured by the camera 202, evaluated to recognize objects 206, and utilized in a comparison 208 with the opportunities 210 matching the location 418. As a still further variation, the image capturing and/or object recognition may be further limited, e.g., to images 204 captured by the camera 202 at the request of the user 104 (which may also indicate greater confidence regarding the interest by the user 104 in the object 206 than for objects 206 detected in spontaneously captured images 204). Alternatively or additionally, the comparison of the location 418 of the device 112 with the locations 418 of the opportunities 210 may be performed only after the location 418 of the device 112 is determined to be associated with the location 418 of the opportunity 210 for more than a lingering duration threshold (e.g., to distinguish instances of the user 104 occupying a location 418 of interest, such as a competitor location of a competitor of an advertiser 120, where a competing opportunity 210 and competing advertisement 122 may be relevant, from instances of the user 104 simply passing through or near the location 418 and is not interested in the products 108 or objects 206 presented therein).

As a second example of this third variation, the device 112 may be configured not to store the advertisements 122. Instead, the device 112 may be configured to store the locations 418 and advertisers 120 associated with respective opportunities 210, and to contact the advertiser 120 for an advertisement 122 only upon detecting the location 418 of the device 112 identified as an opportunity 210 to present the advertisement 122. This variation may reduce the storage costs of the implementation of the techniques presented on herein on a mobile device 112 with limited (or even no available) storage capacity.

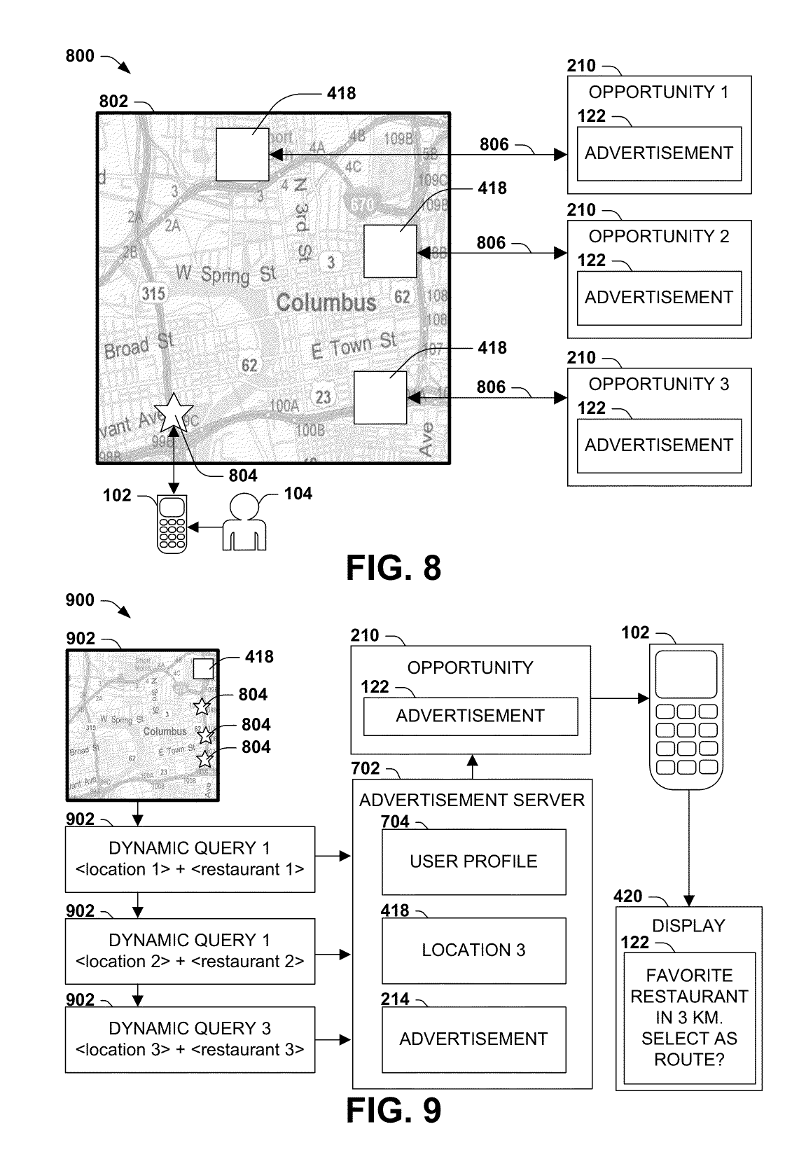

FIG. 8 presents an illustration of an exemplary scenario 800 involving an implementation of the techniques presented herein that may provide this type of efficiency. In this exemplary scenario 800, the device 112 of the user 104 may store a set of opportunities 210 comprising an advertisement 122 and a location 418, and may periodically receive the current location 804 from the geolocator 416 for comparison with the locations 418 of the opportunities 210. As one such example, the locations 418 of the opportunities 210 may be specified as a set of triggers, and the device 112 may automatically compare these opportunities 210 with each location 418 reported by the geolocator 416 to any application. Moreover, the opportunities 210 involved in this comparison may be limited to those within a region 802 of the device 112. Upon identifying a match between the current location 804 of the device 112 and the location 418 associated 804 with an opportunity 210, the device 112 may then activate the camera 202, capture the images 204 of the environment of the user 104, recognize the objects 206 in the images 204, and perform the comparison 208 to determine an advertisement 122 relating to both the current location 804 of the device 112 and the objects 206 recognized in one or more images 204. Upon detecting a matching opportunity 212, the device 112 may present the advertisement 122 to the user 104. In this manner, the use of computational resources for the comparison 208 may be limited to circumstances with a significant likelihood of identifying an opportunity 210, while conserving the battery, processor, memory, and storage capacity of the device 112, while utilizing the techniques presented herein.

As a third example of this third aspect, the current location 804 of a user 104 and device 102 may be frequently or continuously changing (e.g., while the user 104 is traveling). In such scenarios, the device 102 may monitor the current location 804 of the user 104 and the interests of the user 104, which may be inferred from the objects 206 recognized in the images 204 captured by the camera 202 at the request of the user 104. As a first example, if the user 104 is traveling in a region 802 and taking photos of restaurants and food, the device 102 may be able to recognize an opportunity 210 to present advertisements 122 relating to restaurants in the region 802 associated with the current location 804 of the user 102. As a second example, if the user 104 is detected (e.g., using gaze-tracking techniques) to be gazing at museums in a particular region 802, the device 102 may identify an opportunity 210 to present an advertisement 122 for a similar museum in the same region 802. As one such example, these items may be formulated as a dynamic query that is presented to an advertisement server 702 that is capable of identifying and presenting opportunities near the location 418 of the user 104 and relating to the current interests of the user 104, as determined by the objects 206 that the user 104 appears to be viewing. The dynamic query may be periodically or continuously updated as the user 104 continues to travel and as the transient interests of the user 104 change, and may be evaluated against a set of opportunities 210 that may match the dynamic conditions of the user 104. Such detected opportunities 210 may be further selected by comparing the location 418 and the recognized objects 206 with the interests of the user 104 recorded by an advertisement server 702.

FIG. 9 presents an illustration of another exemplary scenario for implementing the techniques presented herein, involving a user 104 traveling within a region 802 (e.g., driving along a street), such that the device 102 may detect an updating current location 804 of the user 104. Additionally, the device 102 may determine, through images 204 captured by the camera 202 of the device 102, that the user 104 is looking at or for restaurants. (For example, the user 104 may be taking images 204 of restaurants to send to other users 104 in a discussion of where to eat, or the user 104 may be requesting more information about local objects 206 through an augmented reality mapping application, and to this end may point the camera 202 of the device 102 at respective restaurants.) In order to identify opportunities 210 relating to the current location 804 and current interests of the user 104, the device 102 may generate a set of dynamic queries 902 identifying a dynamic current location 804 and a set of interests associated with the objects 206 viewed through the camera 202. This information may be sent to an advertisement server 702 that compares location 418 and the objects 206 with the opportunities 210, and may eventually identify a matching opportunity 212 that is relevant to this information. Moreover, the matching opportunity 212 may be selected in relation to the user profile 704 describing the user 104, therefore identifying not only advertisements 214 for restaurants having a location 418 near the current location 804 of the user 104, but also identified as a favorite restaurant of the user 104. The matching opportunity 212 may be sent to the device 102, which may present the advertisement 122 for the nearby favorite restaurant of the user 104 on the display. In this manner, the advertisement server 702 may participate in the evaluation of dynamic queries 902 associated with the changing current locations 804, the transient interests of the user 104 identified through the evaluation of images 204 captured by the camera 202 of the device 102, and the description of the user represented in the user profile 704. These and other variations in the advertisement infrastructure may be selected for various implementations of the techniques presented herein.

D4. Opportunity and Advertisement Selection

A fourth aspect that may vary among embodiments of these techniques involves additional considerations that may be included in selecting a matching opportunity 212 for a particular object 206 and location 418.

As a first variation of this fourth aspect, in some cases, a comparison 208 may identify two or more opportunities 210 that may match an object 206 and a location 418. In such scenarios, the device 112 may simply present all of the opportunities 210 as matching opportunities 212, and allow the user 104 to select among them. Alternatively, the device 112 may perform a selection among the set of opportunities 210 plurality of competing opportunities and advertisements 122 that match an object 206 and a location 418 during the comparison 208 in order to select the matching opportunity 212 and the advertisement 122 to display. As a first such example, the device 112 may select the opportunity 210 having an advertisement 122 that is likely to be more appealing to the user 104 (e.g., the offer 110 having the lowest-priced offer 110 for the product 108, the offer 110 having the highest predicted relevance to the interests of the user 104, or the store 106 that is nearest to the location 418), thereby maximizing the advantage of the presentation of advertisements to the user 104. As a second such example, the device 112 may select the matching opportunity 212 having a higher advertisement fee 216 than the other competing opportunities 210, thereby maximizing the collection of advertisement fees 216. As a third such example, the device 112 may remove opportunities 210 and/or advertisements 122 that have previously been presented to the user 104 in order to rotate the advertisements 122. As a first further variation, this selection may be performed during the comparison 208, or at an earlier time; e.g., upon receiving and storing opportunities 210 and generating triggers for the locations 418 specified thereby, the device 112 may perform the selection and remove the un-selected opportunities 210 for the location 418 (e.g., selecting a first advertisement 122 comprising a first advertisement fee 216, and removing a second opportunity 210 that is associated with a second advertisement 122 and a second advertisement fee 216 that is less appealing to the user 104 than the first advertisement fee 216). As a second further variation, upon identifying two or more competing opportunities 210, the device 112 may contact each advertiser 120 to initiate an auction between the opportunities 210, further maximizing the advertisement fees 216 and/or the value of the offers 110 to the user 104.

As a second variation of this fourth aspect, the selection of matching opportunities 212 may also involve a consideration of the current activity and available attention of the user 104. For example, in addition to detecting the location 418 and the objects 206 in the image 204, the device 112 may be capable of detecting a current activity of the user 104, and infer the availability of the user's attention for the presentation of advertisements 122. For example, the detection of a static location 418 in an area that is not interesting, an evaluation of an image 204 of the user 104 and an audio input through a microphone of the device 112, and/or a detection of the type of interaction of the user 104 with the device 112 may indicate that the user 104 is waiting idly; is shopping for or examining a product; is waiting in line to complete a transaction with a product 108; or is engaged in conversation with another individual. Alternatively, the user 104 may simply indicate his or her current activity for the device 112. These activities may be associated with an inference of the irritation to the user 104 of interrupting the current activity with an advertisement 122, which may be represented as an interruption cost. If the advertisement fee 216 for an opportunity 210 does not adequately compensate for the interruption of the user 104, then the opportunity 210 and advertisement 122 may not be selected as the matching opportunity 212 for the presentation of the advertisement 122. These costs and the detection of activities 1002 may also be adjusted, e.g., in view of the past presentation of advertisements 214 (e.g., configuring the device 112 to raise the interruption cost 1004 with each presented advertisement 214 in order to limit the number of interruptions, and/or varying the interruption costs 1004 based on a request by the user 104 to present or withhold advertisements 214).

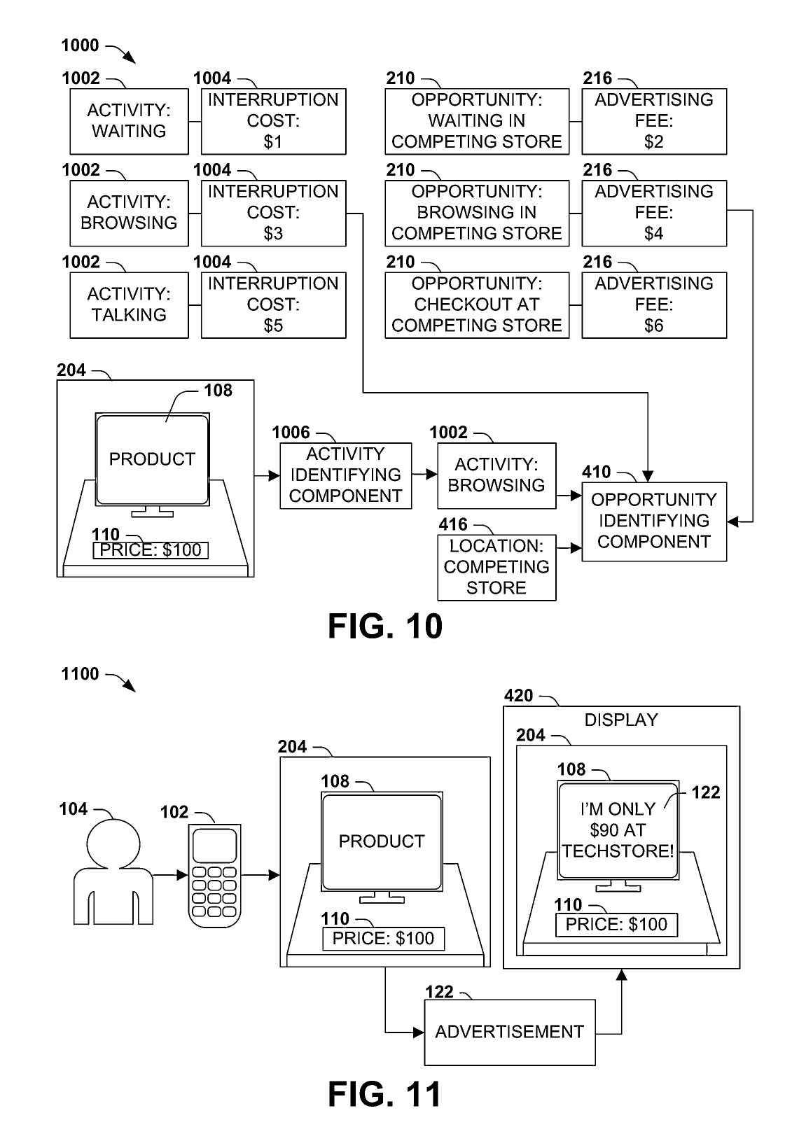

FIG. 10 presents an illustration of an exemplary scenario 1000 featuring this technique, wherein a device 112 comprises an activity identifying component 1006 that is capable of comparing a set of recognizable activities 1002 with the location 418, the recognized objects 206 in one or more images 204, the actions of the user 104, and sensory data of the environment to identify the current activity 1002 of the user 104. Each activity 1002 may be associated with an interruption cost 1004 that is compared with the advertising fee 216 of each opportunity 210 matching the location 418 of the user 104 and the images 204 and objects 206 recognized from the images 204 captured by the camera 202 of the device 112. For example, a low interruption cost 1004 may be assigned to an idle or waiting activity; a moderately high interruption cost 1004 may be assigned to a browsing activity 1002; and a very high interruption cost 1004 may be assigned to the activity 1002 of talking to another individual. The irritation of an interruption may vary for the respective activities 1002, and the advertising fees 216 may vary according to the interest of the advertiser 214 in interrupting the activity 1002. For example, if the user 104 is browsing in a competing store, the opportunity 210 of interrupting the user 104 with a more appealing offer for the same product 112 may be considerably high, and perhaps higher still if the user 104 is detected to be talking to an individual while in the checkout line of the competing store. Conversely, if the advertising fee 216 is insufficient to compensate for the interruption cost 1004, the advertisement 214 may be withheld. In this manner, the opportunity identifying component 410 of the device 112 may perform the selection of opportunities 210 while considering the cost of interrupting the activity 1002 of the user 104. These and other variations in the selection of a matching opportunity 212 may be devised and included in embodiments of the techniques presented herein.

D5. Advertisement Presentation

A fifth aspect that may vary among embodiments of these techniques relates to the presentation of advertisements 214 to the user 104 of the device 112.

As a first variation of this fifth aspect, the advertisement 122 associated with a matching opportunity 212 may be presented to the user 104 in many ways, such as an email message, a text message, an alert or notification on the phone 112, or an addition of a visual indicator to an application executing on the device 112 (e.g., a marker presented in a mapping application). Additionally, the advertisement 122 may be integrated with the image 204 of the environment that is presented to the user 104, thus providing an “augmented reality” advertisement relating to the recognized objects 206 in the image 204.

FIG. 11 presents an illustration of an exemplary scenario 1100 featuring an “augmented reality” presentation of the advertisement 214 in accordance with the techniques presented herein. In this exemplary scenario 1100, the device 112 of the user 104 captures an image 204 of the environment of the user 104, and recognizes a product 108 provided at a particular offer 110. Using the recognition of the product 108 and the location 418 detected by the geolocator 416, the device 112 may identify an opportunity and an advertisement 122 for the product 108 through a more appealing offer 110 from the advertiser 120. Moreover, the device 112 may detect and evaluate an offer 110 for the product 108, and may use this information to develop a more appealing competing offer 110 to be presented in the advertisement 122. Additionally, the device 112 may integrate the advertisement 122 with the depiction of the product 108 in the image 204 for presentation to the user 104 on the device 112 (e.g., for a product 108 comprising a television, rendering the advertisement 122 as if displayed by the television), thus raising the clever and appealing presentation of the advertisement 122.

As a second variation of this fifth aspect, the presentation of the advertisement 122 may result in the collection of advertising fees 216 in various ways. As a first example, the advertising fee 216 may be collected from the advertiser 122 upon requesting and receiving the advertisement 122 for presentation. As a second example, the advertising fee 216 may be collected from the advertiser 122 promptly after presenting the advertisement 122, and/or upon detecting a subsequent action of the user 104 that is responsive to the presented advertisement 122, such as completing the transaction with the advertiser 120 presented in the advertisement 122. As a third example, the advertising fee 216 due from the advertiser 120 may be stored and collected at a later date, e.g., as a periodic advertisement collection. Additionally, the collected advertising fees 216 may be directly provided to the user 104; may be used to subsidize the advertised transaction; may be used to subsidize the cost of the device 112 and/or service therefor for the user 104; and/or collected by the manufacturer of the device 112. These and other techniques may be utilized in the presentation of advertisements 122 and collection of advertising fees 216 while implementing the techniques presented herein.

### E. Computing Environment

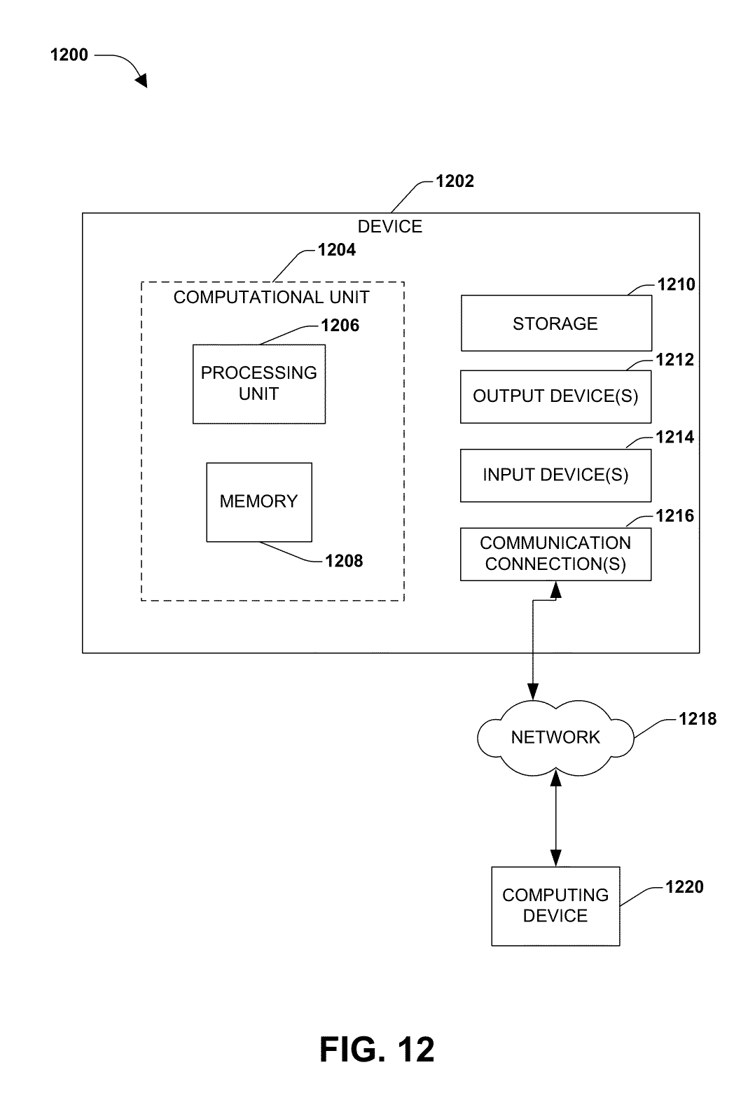

FIG. 12 presents an illustration of an exemplary computing environment within a computing device 1202 wherein the techniques presented herein may be implemented. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, and distributed computing environments that include any of the above systems or devices.

FIG. 12 illustrates an example of a system 1200 comprising a computing device 1202 configured to implement one or more embodiments provided herein. In one configuration, the computing device 1202 includes at least one processor 1206 and at least one memory component 1208. Depending on the exact configuration and type of computing device, the memory component 1208 may be volatile (such as RAM, for example), non-volatile (such as ROM, flash memory, etc., for example) or an intermediate or hybrid type of memory component. This configuration is illustrated in FIG. 12 by dashed line 1204.

In some embodiments, device 1202 may include additional features and/or functionality. For example, device 1202 may include one or more additional storage components 1210, including, but not limited to, a hard disk drive, a solid-state storage device, and/or other removable or non-removable magnetic or optical media. In one embodiment, computer-readable and processor-executable instructions implementing one or more embodiments provided herein are stored in the storage component 1210. The storage component 1210 may also store other data objects, such as components of an operating system, executable binaries comprising one or more applications, programming libraries (e.g., application programming interfaces (APIs), media objects, and documentation. The computer-readable instructions may be loaded in the memory component 1208 for execution by the processor 1206.

The computing device 1202 may also include one or more communication components 1216 that allows the computing device 1202 to communicate with other devices. The one or more communication components 1116 may comprise (e.g.) a modem, a Network Interface Card (NIC), a radiofrequency transmitter/receiver, an infrared port, and a universal serial bus (USB) USB connection. Such communication components 1216 may comprise a wired connection (connecting to a network through a physical cord, cable, or wire) or a wireless connection (communicating wirelessly with a networking device, such as through visible light, infrared, or one or more radiofrequencies.

The computing device 1202 may include one or more input components 1214, such as keyboard, mouse, pen, voice input device, touch input device, infrared cameras, or video input devices, and/or one or more output components 1212, such as one or more displays, speakers, and printers. The input components 1214 and/or output components 1212 may be connected to the computing device 1202 via a wired connection, a wireless connection, or any combination thereof. In one embodiment, an input component 1214 or an output component 1212 from another computing device may be used as input components 1214 and/or output components 1212 for the computing device 1202.

The components of the computing device 1202 may be connected by various interconnects, such as a bus. Such interconnects may include a Peripheral Component Interconnect (PCI), such as PCI Express, a Universal Serial Bus (USB), firewire (IEEE 794), an optical bus structure, and the like. In another embodiment, components of the computing device 1202 may be interconnected by a network. For example, the memory component 1208 may be comprised of multiple physical memory units located in different physical locations interconnected by a network.

Those skilled in the art will realize that storage devices utilized to store computer readable instructions may be distributed across a network. For example, a computing device 1220 accessible via a network 1218 may store computer readable instructions to implement one or more embodiments provided herein. The computing device 1202 may access the computing device 1220 and download a part or all of the computer readable instructions for execution. Alternatively, the computing device 1202 may download pieces of the computer readable instructions, as needed, or some instructions may be executed at the computing device 1202 and some at computing device 1220.

### F. Usage of Terms

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method of presenting advertisements to a user of a device having a processor, a camera, a geolocator, and a display, the method comprising:
executing on the processor instructions configured to, upon receiving a location from the geolocator and an image of an environment of the user from the camera:
evaluate the image to identify at least one object viewed by the user;
compare the at least one object and the location with at least one opportunity associated with an advertisement and an advertisement fee; and
upon identifying a matching opportunity:
present the advertisement associated with the matching opportunity to the user; and
charge the advertisement fee of the matching opportunity to the advertiser.

2. The method of claim 1:
the object comprising a first product associated with the opportunity; and
the advertisement involving an offer for a second product that is associated with the first product.

3. The method of claim 1:
the object comprising a product associated with the opportunity;
evaluating the image comprising: identifying a user interaction with the product; and
the opportunity comprising: identifying the user interaction with the product for a product interaction duration exceeding a product interaction duration threshold.

4. The method of claim 1:
the location comprising a competitor of the advertiser; and
the object comprising a product offered by the competitor at a first product offer;
the advertisement comprising an offer for the product at the advertiser at a second product offer that is more appealing to the user than the first product offer.

5. The method of claim 4, the instructions further configured to, upon identifying the matching opportunity:
evaluate the image to detect the first product offer of the competitor; and
formulate the second product offer that is more appealing to the user than the first product offer.

6. The method of claim 1, the instructions further configured to, upon identifying at least two competing opportunities that are associated with the object and the location, select a matching opportunity among the at least two competing opportunities.

7. The method of claim 6, selecting the matching opportunity comprising: selecting the matching opportunity that is more appealing to the user than other competing opportunities.

8. The method of claim 6, selecting the matching opportunity comprising: selecting the matching opportunity having a higher advertisement fee than other competing opportunities.

9. A system for presenting advertisements to a user of a device having a processor, a camera, a geolocator, a memory, and a display, the system comprising:
an opportunity identifying component comprising instructions stored in the memory that, when executed on the processor, upon receiving a location from the geolocator and an image of an environment of the user from the camera:
evaluate the image to identify at least one object viewed by the user, and
compare the at least one object and the location with at least one opportunity associated with an advertisement and an advertisement fee; and
an advertisement presenting component comprising instructions stored in the memory that, when executed on the processor, upon the opportunity identifying component identifying a matching opportunity:
present the advertisement associated with the matching opportunity to the user; and
charge the advertisement fee of the matching opportunity to the advertiser.

10. The system of claim 9:
the system further comprising: an advertisement store comprising instructions stored in the memory that, when executed on the processor, upon receiving at least one opportunity associated with an advertisement and an advertisement fee before evaluating the image, store the opportunity; and
the opportunity identifying component configured to compare the at least one object and the location with the at least one opportunity stored by the advertisement store.

11. The system of claim 10:
the system further comprising a user profile describing the user; and
the instructions of the advertisement store further comprising:
generating a dynamic query comparing the location of the user and the at least one object identified in the image with advertisement opportunities and the user profile of the user; and
evaluating the dynamic query against the opportunities to identify a matching opportunity that matches the location of the user, the at least one object, and the user profile of the user.

12. The system of claim 10, the instructions of the advertisement store further configured to, upon receiving a first opportunity associated with a first advertisement comprising a first advertisement fee and a second opportunity that is associated comprising a second advertisement fee that is less appealing to the user than the first advertisement fee, remove the second advertisement and the second opportunity from the advertisement store.

13. The system of claim 9:
the instructions of the opportunity identifying component further comprising: among the at least one opportunity, compare the location received from the geolocator; and
the opportunity identifying component configured to evaluate the image only upon detecting that at least one opportunity is associated with the location.

14. The system of claim 13:
at least one opportunity comprising a competing opportunity comprising a competitor location associated with a competitor of the advertiser; and
the opportunity identifying component configured to evaluate the image only when the location is associated with the competitor location for a location duration that exceeds a lingering duration threshold.

15. The system of claim 13, the instructions of the opportunity identifying component further comprising: upon detecting that an opportunity is associated with the location, request the advertisement from the advertiser associated with the opportunity.

16. A nonvolatile computer-readable storage medium comprising instructions that, when executed on a processor of a device having a camera, a geolocator, and a display, present advertisements by, upon receiving a location from the geolocator and an image of an environment of the user from the camera:
evaluating the image to identify at least one object viewed by the user;
comparing the at least one object and the location with at least one opportunity associated with an advertisement and an advertisement fee; and
upon identifying a matching opportunity:
present the advertisement associated with the matching opportunity to the user; and
charging the advertisement fee of the matching opportunity to the advertiser.

17. The nonvolatile computer-readable storage medium of claim 16, identifying the matching opportunity further comprising: identifying the matching opportunity associated with the object and the location and having an advertising fee exceeding an interruption cost of interrupting the user.

18. The nonvolatile computer-readable storage medium of claim 17, the instructions further configured to:
identify an activity of the user; and
select the interruption cost based on the activity of the user.

19. The nonvolatile computer-readable storage medium of claim 16, presenting the advertisement comprising:
integrating the advertisement with the image of the environment of the user captured by the camera; and
presenting the image of the environment to the user.

20. The nonvolatile computer-readable storage medium of claim 16:
the object comprising a product associated with the opportunity and involved in a transaction between the user and a competitor of the advertiser; and
presenting the advertisement comprising: presenting an advertisement associated with the product before a completion of the transaction with the competitor for the product.
